(19) United States
(12) Patent Application Publication
(10) Pub. No.: US 2012/0261494 A1
(43) Pub. Date: Oct. 18, 2012

(54) PAINT SPRAYING DEVICE

(75) Inventors: Elmar KRAYER, Langenargen (DE); Alfred GÖHRING, Salem (DE); Thomas JELTSCH, Friedrichshafen (DE); Jens ULBRICH, Friedrichshafen (DE); Christoph WELTE, Uberlingen (DE)

(73) Assignee: J. Wagner GmbH, Markdorf (DE)

(21) Appl. No.: 13/431,134

(22) Filed: Mar. 27, 2012

Related U.S. Application Data
(63) Continuation of application No. PCT/DE2010/001106, filed on Sep. 22, 2010.

(30) Foreign Application Priority Data
Oct. 2, 2009 (DE) 10 2009 048 023.4

(51) Int. Cl. B05B 7/04

(52) U.S. Cl. 239/398

(57) ABSTRACT

The invention relates to a paint spraying device comprising an operator unit arranged at a first end of the paint spraying device and a spray head arranged at a second end of the paint spraying device, wherein the operator unit has an air connection for an air line. The operator unit has a guide for a paint line, via which the spray head is supplied with paint, the operator unit comprises a signal transducer for generating a control signal, the operator unit has a control connection for a control line, a barrel is arranged between the operator unit and the spray head, and an air stream is led from the operator unit to the spray head through the barrel.

### CROSS REFERENCE TO RELATED APPLICATIONS

This application is a continuation of International Application No. PCT/DE2010/001106 filed Sep. 22, 2010, which designated the United States, and claims the benefit under 35 USC §119(a)-(d) of German Application No. 10 2009 048 023.4 filed Oct. 2, 2009, the entireties of which are incorporated herein by reference.

### FIELD OF THE INVENTION

The invention relates to a paint spraying device.

### BACKGROUND OF THE INVENTION

A paint spraying device which comprises an operator unit arranged at a first end of the paint spraying device and a spray head arranged at a second end of the paint spraying head is known from DE 20 2007 005 381 U1, wherein the operator unit has an air connection for an air line. With paint spraying devices of this type, a user requires additional tools, such as ladders or scaffold structures, in order to spray areas such as walls or ceilings which lie beyond arm's reach, and the user becomes tired from constantly having to carry with him the paint tank during the spraying action.

### SUMMARY OF THE INVENTION

The object of the invention is to propose a paint spraying device which, where possible, frees the user from having to use a ladder or scaffold structure, in particular when spraying walls or ceilings, and which is lightweight.

In the paint spraying device according to the invention the operator unit has a guide for a paint line, a signal transducer for generating a control signal, and a control connection for a control line, wherein a barrel is arranged between the operator unit and the spray head and an air stream is led from the operator unit to the spray head through the barrel, and wherein the spray head is supplied with paint by the paint line. On the one hand, a paint spraying device of this type, which will also be referred to hereinafter as a paint spraying lance, has a greater reach owing to the barrel arranged between the operator unit and the spray head so that, where possible, the user can dispense with the use of additional tools such as ladders or scaffold structures, in particular when spraying walls and ceilings. On the other hand, the physical burden placed on the user is considerably reduced, since it is possible to dispense with a paint tank on the spray head as a result of the feed of paint to the spray head via the operator unit. Furthermore, the physical burden can also be reduced since the paint spraying device according to the invention can also be gripped by the user in the region of the barrel arranged between the operator unit and the spray head, and therefore two-handed operation is possible, the user gripping the paint spraying device according to the invention with one hand on the operator unit and with the other hand on the barrel. Steadier and more controlled movements are also possible during the spraying process as a result of this two-handed operation. The core of the invention is therefore a paint spraying device which, as a result of its design, enables a specific paint feed, makes it possible to control the spray head and paint supply remotely at the operator unit, and makes it possible for work to be performed ergonomically at low weight load, without disadvantages having to be faced during operation.

In one variant of the invention, a pneumatic control signal is generated by means of the signal transducer and is passed on via a first control line formed as a pneumatic control line, and, in order to transfer the control signal, the operator unit is equipped in particular with a control connection formed as a control air connection for the pneumatic control line. Control can thus also be implemented economically over greater distances of a few meters, it being easy to visually monitor the function of said control.

In a further variant of the invention, an electric control signal is generated by means of the signal transducer (S) and is passed on via a first control line formed as an electric control line, and, in order to transfer the control signal, the operator unit is equipped in particular with a control connection formed as an electric connection for a single-core or multi-core cable. With an embodiment of this type it is particularly easy to arrange an indicator lamp on the operator unit, said lamp providing information regarding the switched state.

In a variant of the invention, the second control line is formed in particular as a mechanical control line, and the control connection is formed in particular as a coupling means for the mechanical control line, wherein the mechanical control line is formed in particular as a pulling means, and in particular as a control cable or Bowden cable or pull rod. A mechanism for remote control is thus provided, the function of which can be easily checked and upon actuation of which the user receives a direct confirmation of the functional efficiency via the necessary actuation force and is therefore also reminded to carry out maintenance measures.

In a further variant of the invention, the second control line is formed in particular as an electric control line, and the control connection is formed in particular as an electric connection for a single-core or multi-core cable. In an embodiment of this type, it is particularly easy to arrange an indicator lamp on the operator unit, said lamp providing information regarding the switched state.

In a third variant, the second control line is formed in particular as a pneumatic control line, and the control connection is formed in particular as a control air connection for a pneumatic control line formed as a control hose. Control can thus also be implemented economically over greater distances of a few meters, it being easy to visually monitor the function of said control.

In accordance with the invention at least one working unit, in particular a pump for the paint and/or a fan for the air stream, is controlled, and in particular is switched on and switched off, by means of the first control line via a trigger arranged on the operator unit. Without forfeiting operating comfort, it is thus possible in accordance with the invention to use a floorstanding pump and/or a floorstanding fan in particular, since this can be operated by the operator unit via the first control line.

Furthermore, according to the invention a paint valve, which is arranged in the spray head, is controlled, and in particular is opened and closed, by means of the second control line via a trigger arranged on the operator unit. Owing to the use of the second control line, it is possible use the operator unit to operate the paint valve which is arranged in the spray head and which lies outside the user's reach when work is performed.

According to the invention the barrel is also formed with a tubular duct to guide the air stream, and in particular a groove extending parallel to the duct is provided in the barrel, the paint line and in particular the second control line being guided in said groove, wherein the control line in particular is guided between the paint line and the tubular duct. As a result of this simple design of the barrel, it is possible to form the barrel as a simple extrusion part which can be produced in any length. The specific arrangement of the second control line between the paint line and the tubular duct ensures protection of the second control line against contamination, since the groove is closed by the paint line with formation of a further tubular duct.

Furthermore, according to the invention at least one opening is formed in a sheathing of the tubular duct of the barrel, which is provided to guide the air stream, it being possible for said opening to be closed by at least one closure means, wherein the closure means is guided along the barrel. It is thus possible with the paint spraying device according to the invention to temporarily reduce a pressure of the air stream flowing through the duct by releasing the opening, without a fan of variable output having to be provided. A spray jet exiting from the spray head can thus be changed easily by the operator, since the closure means can be actuated during work using his hand located on the barrel. It is advantageous to arrange this opening in the vicinity of the operator unit, since it is easily accessible to the user in this region.

In accordance with the invention the closure means is formed by at least one slide formed in particular as a clasp or sleeve, wherein the slide engages over or surrounds the barrel and is displaceable and/or rotatable on the barrel, wherein the closure means covers at least one of the openings in a first position, and wherein the closure means releases at least one of the openings in a second position. With a design of this type the pressure of the air stream can be changed economically using only one additional component.

Furthermore, according to the invention the barrel is formed of at least two barrel portions, and in this case adjacent barrel portions are connected by means of an adapter in particular. With a multi-part barrel it is possible for example to form a multiplicity of barrel lengths adapted to the specific requirements if three barrel portions of different length are provided. Owing to the use of an adapter, it is possible to securely connect barrel portions even of extremely simple geometry so that they are capable of bearing a load.

According to the invention, the operator unit is equipped with a coupling attachment which is used to connect the operator unit to the barrel, and the operator unit is equipped with a handpiece and a diagonal strut, wherein the trigger is arranged between the handpiece and the diagonal strut, and wherein the handpiece is formed as an air duct, and wherein the paint is guided towards the coupling attachment in or along the diagonal strut in particular. Owing to the separate guidance of air stream and paint stream in the operator unit, the individual components of the operator unit are kept so slim that they can be grasped easily by the user.

In accordance with the invention the air stream is also deflected in the operator unit by at least 45° in the direction of a longitudinal axis of the barrel, and the longitudinal axis of the barrel is oriented in particular parallel to a spraying direction. The paint spraying device according to the invention is thus kept slim in its front region, and spraying can thus be carried out accurately, even in the corners of rooms.

Lastly, according to the invention the trigger is connected via the pulling means to an actuation means for the paint valve, which is arranged in the spray head, wherein the pulling means is adjustable in length in particular, and wherein the actuation means is formed in particular as a lever which is mounted pivotably on the spray head and moves a needle in particular. The paint valve can thus be operated from the remotely distanced trigger in the usual manner. The pulling means is also fixed detachably at the actuation means or at the spray head. The spray head and the barrel may thus be completely separate from one another.

### BRIEF DESCRIPTION OF THE DRAWINGS

Further details of the invention will be described in the drawing with the aid of schematically illustrated exemplary embodiments.

FIG. 1 shows a side view of a paint spraying device according to the invention and a schematic illustration of a pump and a fan;

FIG. 2 shows an enlarged, perspective view of the operator unit of the paint spraying device shown in FIG. 1, including a symbolically illustrated control unit which is attached to the operator unit;

FIG. 3 shows an enlarged view of the spray head of the paint spraying device shown in FIG. 1, the spray head being shown with the protective cap removed;

FIG. 4 shows a longitudinal section through the illustration of FIG. 3;

FIG. 5 shows a cross-section through the barrel of the paint spraying device corresponding to the sectional line V-V shown in FIG. 1;

FIG. 6 shows an illustration corresponding to FIG. 1 of the paint spraying device, wherein the course of the paint hose and the course of the second control means are additionally illustrated schematically; and

FIG. 7 shows a variant of a paint spraying device according to the invention, in which the barrel is formed in a number of parts.

### DETAILED DESCRIPTION OF THE INVENTION

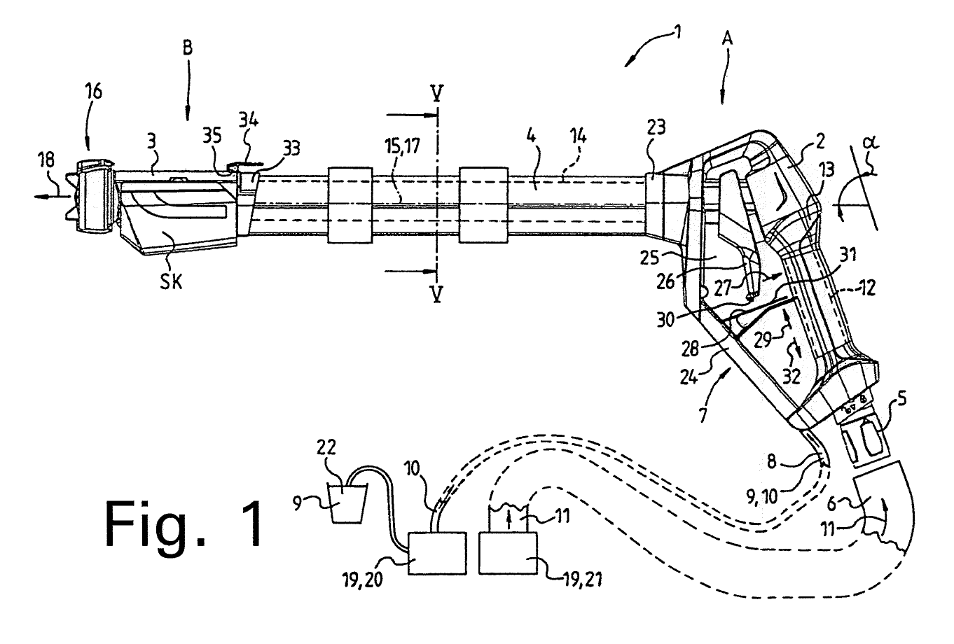

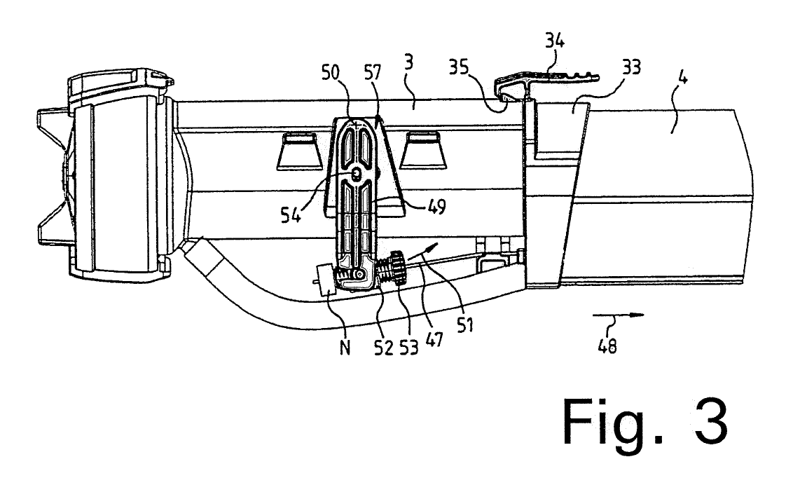

FIG. 1 shows a side view of a paint spraying device 1 according to the invention. The paint spraying device 1 is also referred to as a paint spraying lance. The paint spraying device 1 basically comprises an operator unit 2, a spray head 3, and a barrel 4. The barrel 4 connects the operator unit 2 and the spray head 3. The operator unit 2 is thus arranged at a first end A of the paint spraying device 1, and the spray head 3 is thus arranged at a second end B of the paint spraying device. The operator unit 2 has an air connection 5 for an air line 6 (illustrated schematically). The operator unit 2 also has a guide 7 for a paint line 8, via which the spray head 3 is supplied with paint 9 or a paint stream 10. The paint spraying device 1 is supplied with an air stream 11 via the air line 6. The air stream 11 first flows through an air duct 12, which is formed in a handpiece 13 of the operator unit 2, and then enters a tubular duct 14, which passes through the barrel 4 along a duct axis 15. The tubular duct 14 leads into the spray head 3. In the spray head 3, the air steam 11 fed via the barrel 4 is then blown out through a spray nozzle 16 together with the paint stream 10 and is atomized. A longitudinal axis 17 of the barrel 4 or the duct axis 15 thus extends parallel to a spraying direction 18. In the handpiece 13 of the operator unit 2, the air stream 11 is deflected in its air duct 12 by an angle of deflection a, wherein the angle of deflection a is at least 45° and in particular is between 60° and 90°. Two working units 19 (illustrated schematically) are provided to supply the paint spraying device 1. In this instance a first working unit 19 is formed as a pump 20 which generates the paint stream 10. A second working unit 19 is formed as a fan 21 which generates the air stream 11. The pump 20 is supplied with the paint 9 from a paint container 22. The operator unit 2 is connected to the barrel 4 via a coupling attachment 23, into which the barrel 4 can be inserted. When inserted, the barrel 4 and the operator unit 2 are secured to one another by latching means (not illustrated). In addition to the aforementioned handpiece 13, which is formed between the coupling attachment 23 and the air connection 5, the operator unit 2 also comprises a diagonal strut 24, which likewise connects the coupling attachment 23 and the air connection 5. The operator unit 2 has a trigger 26 in a gap 25 arranged between the diagonal strut 24 and the handpiece 13. This trigger can be actuated from the position illustrated in FIG. 1 in a direction indicated by an arrow 27. In an actuated position (not illustrated in this instance), the trigger 26 can be locked by a securing means 28. The securing means 28 is pressed in a direction of an arrow 29 for this purpose and an extension 30 of the trigger 26 is brought to rest against an extension 31 of the securing means 28. To unlock the effected locking, the securing means 28 is moved in a direction of an arrow 32, opposite the direction of the arrow 29, wherein this movement is carried out automatically by the securing means 28 as a result of a resilient bias and therefore only has to be initiated by the user by a short, reinforced pulling of the trigger 26. The barrel 4 has a coupling attachment 33 to the spray head 3, the spray head 3 being insertable into said coupling attachment. To secure the spray head 3 on the barrel 4, a sprung tab 34, which is connected to the coupling attachment 33, engages over a wedge 35, which is formed on the spray head 3. This is also illustrated in an enlarged view in FIG. 3, wherein FIG. 3 shows the spray head 3 with the protective cap SK removed (see FIG. 1).

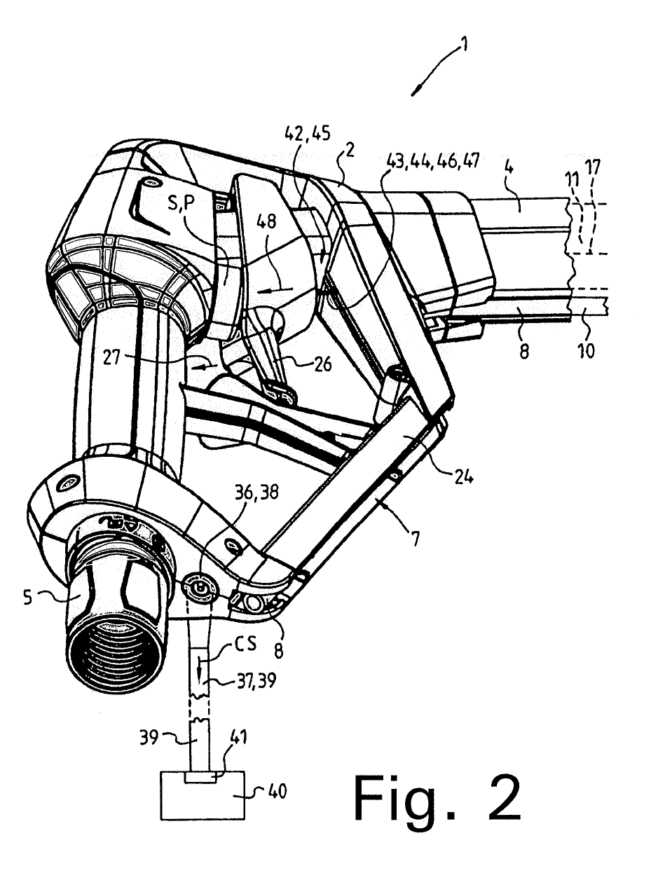

FIG. 2 again shows, in an enlarged perspective view, the operator unit 2 of the paint spraying device 1 shown in FIG. 1. In addition to the air connection 5 already described and the illustrated cut-away paint line 8 already described, a first control connection 36 can also be seen in this view beside the air connection 5. The control connection 36 is provided for attachment of a first control line 37, which is illustrated schematically. The control connection 36 is formed as a control air connection 38 for a pneumatic control line 39. A control signal CS can be generated by actuating the trigger 26. To generate the control signal CS, the trigger 26 acts on a signal transducer S, which is formed as an air pressure generator P. The air pressure generator P builds up an increased air pressure at the control air connection 38, this air pressure being passed on through the pneumatic control line 39. The pneumatic control line 39 leads to a control unit 40, in which the control signal CS, which is present in the form of an increased air pressure, is converted into a switch signal for the pump 20 by means of an electro-pneumatic button 41.

According to a variant (not illustrated), the control connection 36 is also provided as an electric connection for an electric control line. An electric button or switch is then actuated accordingly via the trigger 26.

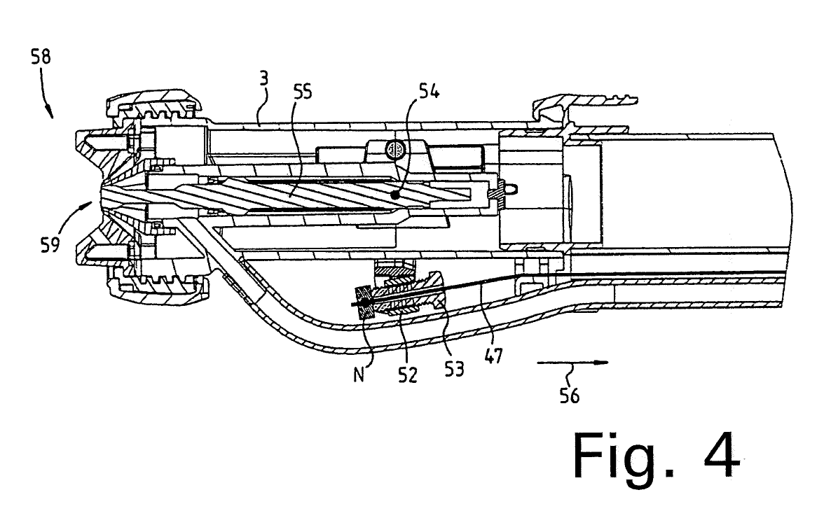

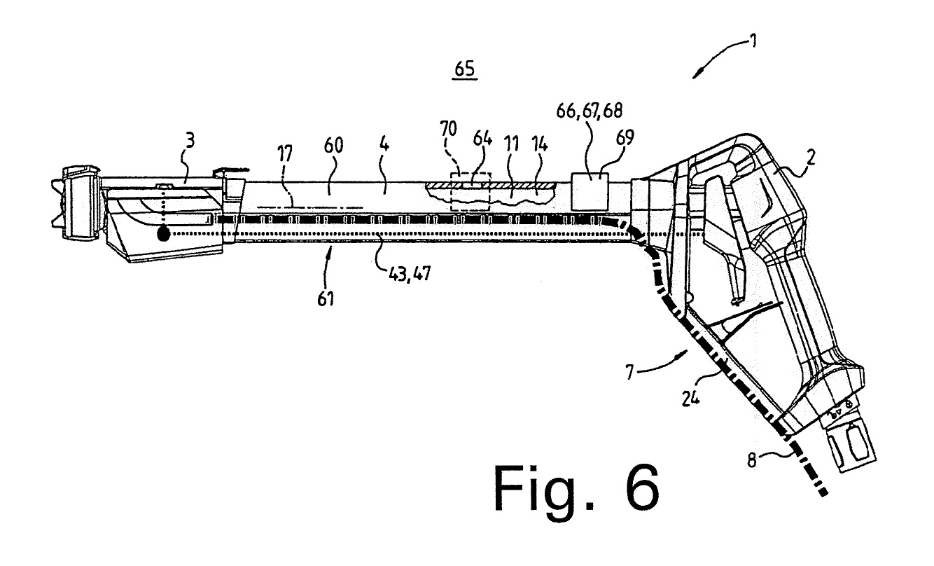

In the illustration of FIG. 2 the guide 7 for the paint line can be seen clearly, formed in the diagonal strut 24. The paint line 8 or paint stream 10 is guided in said guide towards the barrel 4 over a path which deviates from the air stream 11. In the barrel 4, the paint stream 10 and the air stream 11 are guided parallel to one another along the longitudinal axis 17 of the barrel 4. A second control connection 42 for a second control line 43 can also be seen in FIG. 2. The control connection 42 is formed by a coupling means 44, to which a mechanical control line 45 can be fastened. This is formed as a pulling means 46 in the form of a control cable 47. As can be seen from FIG. 6, the second control line 43 is guided from the operator unit 2 to the spray head 3 and extends along the barrel 4. When the trigger 26 is actuated in the direction of the arrow 27, the second control line 43 formed as a control cable 47 is pulled in a direction of an arrow 48 by the trigger 26, which acts as a coupling means 44. As can be seen from FIG. 3, which shows the spray head 3 with the protective cap SK removed, this movement in the direction of the arrow 48 results in a lever 49 being pivoted about an axis of rotation 50 in a direction of an arrow 51. The lever 49 is connected to the control cable 47 via a threaded nut 52 mounted in an articulated manner on the lever 49, wherein the control cable 47 passes through a set screw 53 and comprises a nipple N with which it is secured to the set screw. The set screw 53 is screwed into the threaded nut and is freely rotatable in relation to the control cable 47. This fastening makes it possible to tension or relieve the control cable. The response behavior of the spray head can thus be adapted as the user desires. The lever 49 is connected to a needle 55 via a shaft 54. This is clear when comparing FIGS. 3 and 4, wherein FIG. 4 shows a longitudinal section through the spray head 3 shown in side view in FIG. 3. The described movement of the lever 49 in the direction of the arrow 51 is transferred to the needle 55 via the shaft 54 so that said needle is moved in a direction of an arrow 56. The lever 49 thus forms an actuation means 57 for a paint valve 58, which is a component of the spray head 3. The paint valve 58 basically comprises the needle 55 and a paint outlet 59, which is closed by the needle 55 as shown in FIG. 4 when said needle is not drawn back in the direction of the arrow 56 by means of the control cable 47.

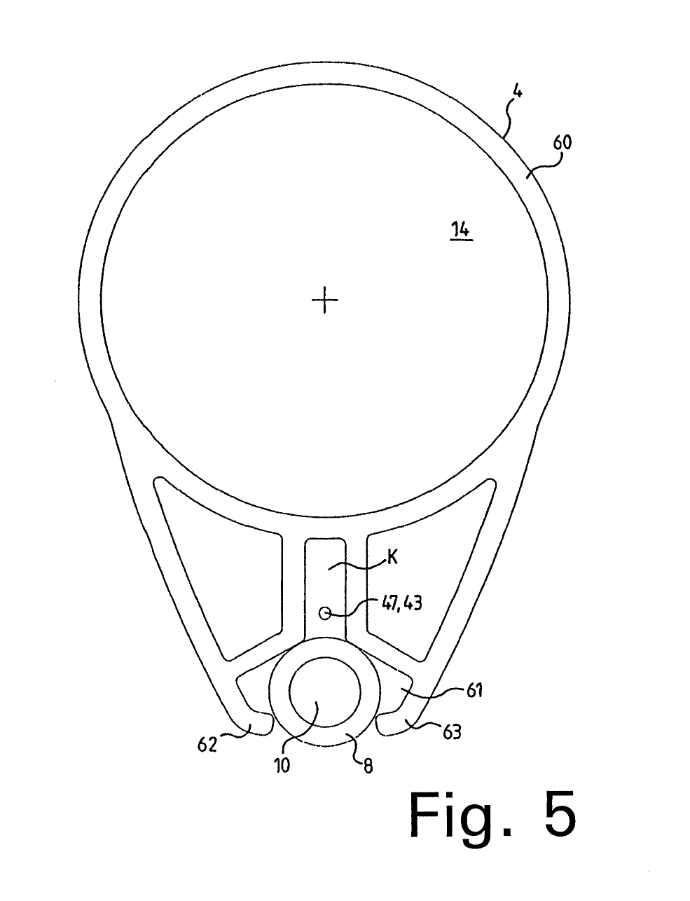

A cross-section through the barrel 4 is illustrated in FIG. 5. The sectional illustration extends in accordance with the sectional line V-V shown in FIG. 1. As already mentioned above, a tubular duct 14 passes through the barrel 4, the air stream 11 flowing in said duct from the operator unit to the spray head. The tubular duct 14 is formed by a sheathing 60 formed as a tube. The paint line 8, in which the paint stream 10 flows to the spray head, extends into and out of the drawing plane, parallel to the tubular duct 14. A groove 61 is formed in an underside of the barrel 4 for guidance of the paint line 8 and is shaped like an upside-down Y in cross-section. The paint line 8 is retained between webs 62 and 63, which form the groove 61. The groove 61 forms an undercut, in which the paint line 8 is retained, wherein the retaining force is generated in particular by a resilient deformation of the paint line 8 and/or by deformation or by the webs 62, 63. A clamping of this type of the paint line 8 in the groove 61 enables repeated assembly and disassembly of the paint line 8 with consistent quality of the connection. The paint line 8 does not fill the groove 61 completely, and therefore a further duct K extending parallel to the tubular duct 14 is formed above the paint line 8, the second control line 43 formed as a control cable 47 being guided in said further duct from the operator unit to the spray head. For reasons of clarity, the cut surfaces have not been hatched in FIG. 5.

The aforementioned FIG. 6 shows the rough course of the paint line 8 in the guide 7 of the diagonal strut 24 of the operator unit 2 and the further course of the paint line 8 in the groove 61 in the barrel 4 as far as the spray head 3. With regard to the course of the paint line in the region of the spray head 3, reference is made to FIGS. 3 and 4, in which it can be seen how the paint line leads into the paint valve 58. Furthermore, the course of the second control line 43, which is formed as a control cable 47, is illustrated schematically. With regard to the precise course of the control cable 47 and of the paint line 8, reference is made to the illustration in FIG. 5. Furthermore, an opening 64 can be seen in FIG. 6 in the sheathing 60 of the barrel 4 due to a partly cut-away illustration of the barrel 4, said opening connecting the tubular duct 14, in which the air stream 11 flows, to an external environment 65. This opening 64, which enables air to flow out from the tubular duct 14 and therefore enables a fall in pressure in the tubular duct 14 and therefore makes it possible to influence the spray jet, can be closed by a closure means 66. The closure means is formed as a slide 67 which, in the form of a clasp 68, engages over the sheathing 60 of the barrel 4. The slide 67 is displaceable from a second position 69 on the sheathing 60, illustrated schematically by a continuous line, into a first position 70 illustrated schematically by dashed lines. In the position 70, the slide 67 closes the opening 64 completely so that no air can escape from the tubular duct 14 through the opening 64. According to one variant (not illustrated), the closure means is formed as a wide rubber ring which is rotatable about the longitudinal axis 17 of the barrel 4 and has one or more openings. The opening 64 is then covered, released or partially released for example by the rubber ring according to the rotated position of said rubber ring.

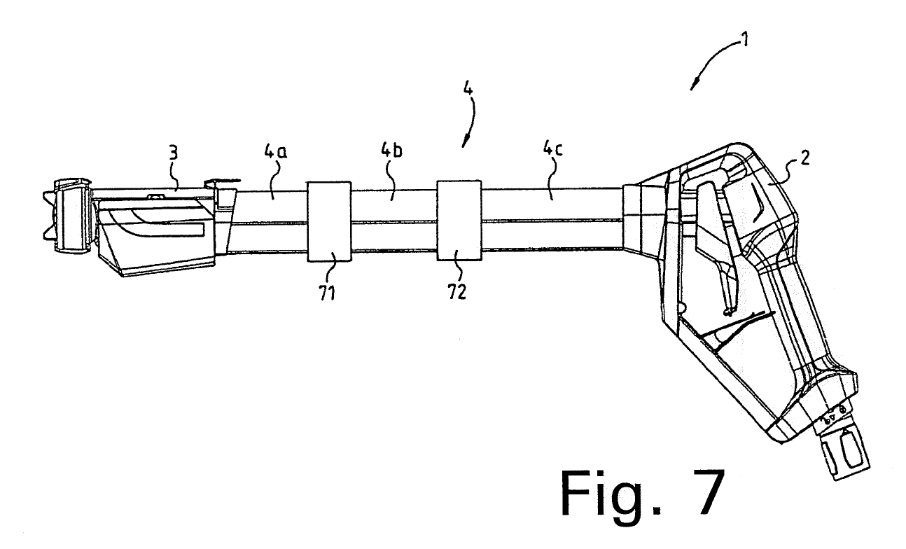

A variant of a paint spraying device 1 is illustrated in FIG. 7. In principle, the paint spraying device 1 illustrated in FIG. 7 has the same structure as the paint spraying device shown in FIGS. 1 to 6. A barrel 4 is arranged between an operator unit 2 and a spray head 3. The barrel 4 consists of three barrel portions 4a, 4b and 4c of different length. In this case, the barrel portions 4a and 4b are interconnected by an adapter 71, and the barrel portions 4b and 4c are interconnected by an adapter 72. In a paint spraying device 1 of this type, it is possible for example to shorten the barrel 4 by removing the barrel portion 4b and the adapter 72, for example if work is to be performed in tight spaces. It is also possible to extend the barrel 4, for example by replacing the barrel portion 4b with a longer barrel portion.

Of course, an extension or shortening of the barrel is also possible in the exemplary embodiment shown in FIGS. 1 to 6. To this end, the barrel used is replaced with a barrel of desired length and the control cable and the paint line are each adapted to the new length. The length is adapted by extension pieces or by new parts, the length of which corresponds to the new requirements.

The paint spraying devices described are dimensioned as “high volume low pressure” devices in which the volume of the air stream and the air pressure at the spray head correspond to the HVLP threshold values, and in which a pressure of approximately 10 psi (approximately 0.7 bar) in particular is not exceeded. The paint spraying device according to the invention is thus designed as a paint spraying lance which is supplied in such a way by the attached working units, which are formed as a paint pump and air fan, that the air pressure of the air stream at the spray head is 10 psi at most.

The invention is not restricted to the exemplary embodiments illustrated or described. Rather, it includes developments of the invention within the scope of the claims.

### LIST OF REFERENCE SIGNS

1 paint spraying device
2 operator unit
3 spray head
4 barrel
4a-4c barrel portion
5 air connection on 2
6 air line
7 guide for 8
8 paint line
9 paint
10 paint stream
11 air stream
12 air duct
13 handpiece of 2
14 tubular duct of 4
15 duct axis
16 spray nozzle
17 longitudinal axis of 4
18 spraying direction
19 working unit
20 pump
21 fan
22 paint container
23 coupling attachment on 2 for 4
24 diagonal strut of 2
25 gap between 13 and 24
26 trigger
27 direction of arrow, movement of 26
28 securing means
29 direction of arrow, movement of 28
30 extension on 26
31 extension on 28
32 direction of arrow, movement of 28
33 coupling attachment on 4
34 tab on 33
35 wedge on 3
36 control connection
37 first control line
38 control air connection
39 pneumatic control line
40 control unit
41 electro-pneumatic button
42 control connection
43 second control line
44 coupling means
45 mechanical control line
46 pulling means
47 control cable
48 direction of arrow
49 lever
50 axis of rotation of 49
51 direction of arrow, movement of 49
52 threaded nut
53 set screw
54 shaft, connection between 49 and 55
55 needle
56 direction of arrow, movement of 55
57 actuation means for 58
58 paint valve
59 paint outlet
60 sheathing
61 groove
62, 63 web of groove
64 opening in 60
65 external environment
66 closure means
67 slide
68 clasp
69 second position of 67
70 first position of 67
71, 72 adapter
A first end of 1
B second end of 1
CS control signal
K duct
N nipple
P air pressure generator
S signal transducer
SK protective cap of 3

1. A paint spraying device comprising:
an operator unit arranged at a first end of the paint spraying device, and
a spray head arranged at a second end of the paint spraying device,
wherein the operator unit comprises
an air connection for an air line,
a guide for a paint line, via which the spray head is supplied with paint,
a signal transducer for generating a control signal, and
a control connection for a control line, and
wherein a barrel arranged between the operator unit and the spray head, and wherein an air stream is led from the operator unit to the spray head through the barrel.

2. The paint spraying device as claimed in claim 1, wherein the signal transducer generates a pneumatic control signal which is passed on via a first control line formed as a pneumatic control line, and, to transfer the control signal, the operator unit has a control connection formed as a control air connection for the pneumatic control line.

3. The paint spraying device as claimed in claim 1, wherein the signal transducer generates an electric control signal which is passed on via a first control line formed as an electric control line, and, to transfer the control signal, the operator unit has a control connection formed as an electric connection for a single-core or multi-core cable.

4. The paint spraying device as claimed in claim 1, wherein the control line is formed as a mechanical control line, and the control connection is formed as a coupling mechanism for the mechanical control line, wherein the mechanical control line is formed as one of a control cable, Bowden cable, and pull rod.

5. The paint spraying device as claimed in claim 1, wherein the control line is formed as an electric control line, and the control connection is formed as an electric connection for a single-core or multi-core cable.

6. The paint spraying device as claimed in claim 1, wherein the control line is formed as a pneumatic control line, and the control connection is formed as a control air connection for a pneumatic control line formed as a control hose.

7. The paint spraying device as claimed in claim 2, wherein at least one of a pump for the paint and a fan for the air stream is switched on and switched off by means of the first control line via a trigger arranged on the operator unit.

8. The paint spraying device as claimed in claim 1, wherein a paint valve arranged in the spray head is opened and closed by means of the control line via a trigger arranged on the operator unit.

9. The paint spraying device as claimed in claim 1, wherein the barrel has a tubular duct for guiding the air stream and has a groove extending parallel to the duct, the paint line and the control line being guided in said groove, wherein the control line is guided between the paint line and the tubular duct.

10. The paint spraying device as claimed in claim 9, wherein the tubular duct for guiding the air stream has at least one opening in its sheathing, wherein the opening can be closed by at least one closure mechanism, wherein the closure mechanism is guided along the barrel.

11. The paint spraying device as claimed in claim 10, wherein the closure mechanism is formed by at least one slide formed as a clasp or sleeve, said slide engaging over or surrounding the barrel and being at least one of displaceable and rotatable on the barrel, wherein the closure mechanism covers at least one of the openings in a first position, and wherein the closure mechanism releases at least one of the openings in a second position.

12. The paint spraying device as claimed in claim 1, wherein the barrel is formed of at least two barrel portions, wherein adjacent barrel portions are connected in particular by means of an adapter.

13. The paint spraying device as claimed in claim 1, wherein the operator unit comprises a coupling attachment for connecting the operator unit to the barrel, a handpiece, and a diagonal strut, wherein a trigger is arranged between the handpiece and the diagonal strut, wherein the handpiece is formed as an air duct, and wherein the paint is guided towards the coupling attachment in or along the diagonal strut.

14. The paint spraying device as claimed in claim 1, wherein the air stream is deflected in the operator unit by at least 45° in the direction of a longitudinal axis of the barrel, and in that the longitudinal axis of the barrel extends parallel to a spraying direction.

15. The paint spraying device as claimed in claim 1, wherein a trigger is connected via a pulling mechanism to an actuator for a paint valve in the spray head, wherein the pulling mechanism is adjustable in length, and wherein the actuator is formed as a lever which is mounted pivotably on the spray head and moves a needle.
